(19) United States
(12) Patent Application Publication
(10) Pub. No.: US 2010/0104874 A1
(43) Pub. Date: Apr. 29, 2010

(54) HIGH PRESSURE SINTERING WITH CARBON ADDITIVES

(75) Inventors: Zhou Yong, Spring, TX (US); Sike Xia, Houston, TX (US); Michael Stewart, Provo, UT (US); Carlo Visintainer, Trento (IT)

Correspondence Address: OSHA, LIANG LLP / SMITH, TWO HOUSTON CENTER, 909 FANNIN STREET, SUITE 3500, HOUSTON, TX, 77010, US

(73) Assignee: Smith International, Inc., Houston, TX (US)

(21) Appl. No.: 12/260,740

(22) Filed: Oct. 29, 2008

(51) Int. Cl. B32B 9/04; B29C 43/00

(52) U.S. Cl. 428/408; 264/122

(57) ABSTRACT

A method for forming a cutting element that includes sintering a mixture comprising carbide particles, a sp²-containing or sp²-convertible carbon additive, and a metallic binder at a first processing condition having a pressure of greater than about 100,000 psi to form a sintered object is disclosed. A method for forming a cutting element that includes sintering a mixture comprising diamond particles and a sp²-containing carbon additive at a first processing condition having a pressure of greater than about 100,000 psi to form a polycrystalline diamond layer is also disclosed, as well as cutting elements having diamond grains non-uniformly distributed therethrough.

### BACKGROUND OF INVENTION

1. Field of the Invention

Embodiments disclosed herein relate generally to composite materials used in cutting tools. In particular, embodiments disclosed herein relate to methods for forming composite materials used in cutting tools.

2. Background Art

Historically, there have been two types of drill bits used drilling earth formations, drag bits and roller cone bits. Roller cone bits include one or more roller cones rotatably mounted to the bit body. These roller cones have a plurality of cutting elements attached thereto that crush, gouge, and scrape rock at the bottom of a hole being drilled. Several types of roller cone drill bits are available for drilling wellbores through earth formations, including insert bits (e.g. tungsten carbide insert bit, TCI) and “milled tooth” bits. The bit bodies and roller cones of roller cone bits are conventionally made of steel. In a milled tooth bit, the cutting elements or teeth are steel and conventionally integrally formed with the cone. In an insert or TCI bit, the cutting elements or inserts are conventionally formed from tungsten carbide, and may optionally include a diamond enhanced tip thereon.

The term “drag bits” refers to those rotary drill bits with no moving elements. Drag bits are often used to drill a variety of rock formations. Drag bits include those having cutting elements or cutters attached to the bit body, which may be a steel bit body or a matrix bit body formed from a matrix material such as tungsten carbide surrounded by an binder material. The cutters may be formed having a substrate or support stud made of carbide, for example tungsten carbide, and an ultra hard cutting surface layer or “table” made of a polycrystalline diamond material or a polycrystalline boron nitride material deposited onto or otherwise bonded to the substrate at an interface surface.

Most cutting elements include a substrate of tungsten carbide, a hard material, interspersed with a binder component, preferably cobalt, which binds the tungsten carbide particles together. When used in drilling earth formations, the primary contact between the tungsten carbide cutting element and the earth formation being drilled is the outer end of the cutting element. Tungsten carbide cutting elements tend to fail by excessive wear because of their softness. Thus, it is beneficial to offer this region of the cutting element greater wear protection.

An outer layer that includes diamond particles, such as a polycrystalline diamond, can provide such improved wear resistance, as compared to the softer tungsten carbide inserts. Such a polycrystalline diamond layer typically includes diamond particles held together by a metal matrix, which also often consists of cobalt. The attachment of the polycrystalline diamond layer to the tungsten carbide substrate may be accomplished by brazing.

During manufacture of the cutting elements, the materials are typically subjected to sintering under high pressures and high temperatures. These manufacturing conditions result in dissimilar materials being bonded to each other. Because of the different thermal expansion rates between the diamond layer and the carbide, thermal residual stresses are induced on the diamond and substrate layers, and at the interface there between after cooling. The residual stress induced on the diamond layer and substrate can often result in insert breakage, fracture or delamination under drilling conditions.

To minimize these deleterious effects, various prior art techniques have included keeping the thickness of the polycrystalline diamond layer to a minimum; use of transition layers (such as polycrystalline cubic boron nitride); use of textured interfaces, etc.

However, there exists a continuing need for improvements in the material properties of composite materials used drilling or cutting tool applications, particularly in techniques which reduce the residual stresses present in diamond/tungsten carbide cutting elements.

### SUMMARY OF INVENTION

In one aspect, embodiments disclosed herein relate to a method for forming a cutting element that includes sintering a mixture comprising carbide particles, a sp²-containing or sp²-convertible carbon additive, and a metallic binder at a first processing condition having a pressure of greater than about 100,000 psi to form a sintered object is disclosed.

In another aspect, embodiments disclosed herein relate to a method for forming a cutting element that includes sintering a mixture comprising diamond particles and a sp²-containing carbon additive at a first processing condition having a pressure of greater than about 100,000 psi to form a polycrystalline diamond layer.

In yet another aspect, embodiments disclosed herein relate to a cutting element that includes a tungsten carbide substrate; and a polycrystalline diamond layer; wherein single diamond grains are non-uniformly distributed through the cutting element.

In yet another aspect, embodiments disclosed herein relate to a cutting element that includes a tungsten carbide substrate; and a polycrystalline diamond layer formed from a mixture of diamond grains and a sp²-containing carbon additive; wherein the sp²-containing carbon additive was non-uniformly distributed through the cutting element.

Other aspects and advantages of the invention will be apparent from the following description and the appended claims.

### BRIEF DESCRIPTION OF DRAWINGS

FIGS. 1A-H show various embodiments of cutters in accordance with the present disclosure.

FIGS. 2A-D show various embodiments of inserts in accordance with the present disclosure.

FIG. 3 is a schematic perspective side view of an insert of the present disclosure.

FIG. 4 is a perspective side view of a roller cone drill bit comprising a number of the inserts of FIG. 3.

FIG. 5 is a perspective side view of a percussion or hammer bit including a number of inserts of the present disclosure.

FIG. 6 is a schematic perspective side view of a shear cutter of the present disclosure.

FIG. 7 is a perspective side view of a drag bit comprising a number of the shear cutters of FIG. 6.

### DETAILED DESCRIPTION

Embodiments disclosed herein generally relate to composite materials used in cutting tools and methods for forming such composite materials. In particular, embodiments disclosed herein relate to forming cutting elements from mixtures containing carbon additives therein and subjecting the mixtures to high pressure sintering. Further, embodiments disclosed herein relate to cutting elements (and methods of forming such cutting elements) that contain a tungsten carbide substrate, a polycrystalline diamond layer disposed thereon, where carbon additives may be mixed with the precursor materials to effect the material properties of the resulting products.

As used herein, “additive” refers to a material that are be added to precursor cutting element composite materials in minor amounts to change the properties of the formed composite material. As used herein, “carbon additives” refers both to crystalline and non-crystalline allotropes of carbon that may be added to precursor cutting element composite materials. Crystalline allotropes of carbon include graphite, which possesses primarily sp² hybridization, and diamond, which possesses primarily sp³ hybridization. Non-crystalline allotropes of carbon include amorphous carbon, which possesses a mixture of sp² and sp³ hybridization and may have some short-range crystalline order, but which does not have long-range order, rendering it non-crystalline. Thus, by subjecting the precursor materials to high pressure sintering, the ratio of sp³ to sp² in the carbon additives may be increased. However, if a substantially sp³ carbon additive is to be used as a precursor material, prior to the high pressure and high temperature sintering, a low pressure sintering may be used to at least partially convert some of the sp³ bonds to sp², so that upon high pressure sintering, there are some sp² bonds available to convert back to sp³.

Thus, embodiments of the present disclosure relate to the increasing the ratio of sp³/sp² hybridization (by converting sp² bonds to sp³) of the carbon additives during the high pressure sintering and formation of the composite materials. Such carbon additives may be contained within one of or both of a tungsten carbide layer or polycrystalline diamond layer.

As used herein, the term polycrystalline diamond, along with the abbreviation “PCD,” refers to the material produced by subjecting individual diamond crystals to sufficiently high pressure and high temperatures that intercrystalline bonding occurs between adjacent diamond crystals.

Further, the term “single diamond grains” is distinguished from the term polycrystalline diamond and refers to embedded diamond grains (containing primarily sp³ hybridization) formed within a matrix of tungsten carbide. Such diamond grains may be formed by subjecting sp² hybridization carbon additives to sufficiently high pressure and high temperatures that at least some conversion of the sp² hybridization to sp³ hybridization occurs (i.e., non-diamond carbon additives are converted to diamond).

However, embodiments disclosed herein also relate to polycrystalline diamond layers formed from diamond grains and sp²-containing carbon additives, whereby upon formation of the polycrystalline diamond layer, the sp² hybridization may also be converted to sp³ carbon, and form interconnected bonds with the diamond grains initially provided, to result in a polycrystalline diamond layer having enhanced bonds as compared to a polycrystalline diamond layer formed without such sp²-containing added therein.

Thus, to form such composite structures, both low pressure sintering as well as high temperature, high pressure sintering may be used. In particular, tungsten carbide components may be subjected to an initial low pressure, high temperature sintering process to form the cemented substrates, after which PCD bodies may be joined thereto with a high pressure, high temperature sintering process. During the high pressure, high temperature sintering, the conversion of sp² hybridization within the carbon additives to sp³ hybridization distributed through the tungsten carbide or diamond matrix may occur. During a low pressure, high temperature sintering process (such as conventionally used in forming a tungsten carbide substrate), at least a portion of sp³ hybridization present in the carbon additives (sp²-convertible carbon additives) present may be converted (graphitized) to sp², which may then be converted back to sp³ during a subsequent high pressure sintering. Additionally, it may also be optional to include a low pressure, low temperature sintering to drive off any organic waxes that might be used to assemble precursor materials.

Additionally, one of ordinary skill in the art would recognize that any combination of traditional sintering processes and high pressure, high temperature processes, as well as multiple cycles of traditional, low pressure sintering processes and high pressure, high temperature processes may also be used in various other embodiments. Various traditional WC sintering processes, as well as high pressure, high temperature processes, are shown below in Table 1.

TABLE 1

| | | |
|---|---|---|
| Technique | Typical Pressure | Typical Temperature |

Traditional WC Sintering

| | | |
|---|---|---|
| Hot Pressing | <14,500 psi | <2200° C. |
| HIP | <43,500 psi | <1600° C. |

High Temperature, High Pressure

| | | |
|---|---|---|
| Rapid Omnidirectional | <145,000 psi | <1800° C. |
| Compaction | | |
| High Temperature High | <1,100,000 psi | <1600° C. |
| Pressure (diamond | | |
| synthesis) | | |

The composites of the present disclosure are also subjected to at least one high pressure process, i.e., pressures upwards of 100,000 psi, to convert sp² carbon present in the precursor mixtures to diamond grains or sp³ carbon, as well as to form intercrystalline bonding in a polycrystalline diamond layer. Examples of high pressure, high temperature (HPHT) process can be found, for example, in U.S. Pat. Nos. 4,694,918; 5,370,195; 4,525,178; 5,676,496 and No. 5,598,621. Thus, for sp²-containing carbon additives provided in a tungsten carbide mixture, the high pressure sintering may allow for the sp²→sp³ conversion of sp²-containing carbon additives, i.e., forming diamond grains distributed through a tungsten carbide matrix, whereas for sp²-containing carbon additives provided among diamond particles, the high pressure sintering may similarly allow for the sp²→sp³ conversion but also allow for intercrystalline bonding among precursor diamond grains as well as the converted carbon additives.

In a particular embodiment, the composites of the present disclosure are subjected to a process having a pressure ranging from 100,000 psi to 1,500,000 psi and a temperature ranging from 500° C. to 1,600° C. In yet a more particular embodiment, a minimum temperature is about 1200° C. and a minimum pressure is about 500,000 psi. Typical processing may be at a pressure of about 650,000 to 1,000,000 psi and 1300-1450° C. Those of ordinary skill will appreciate that a variety of temperatures and pressures may be used, and the scope of the present invention is not limited to specifically referenced temperatures and pressures. The preferred temperature and pressure in a given embodiment may depend on other parameters such as the presence of a catalytic material, such as cobalt, which is used to promote intercrystalline bonding. Further, in forming a polycrystalline diamond layer, one of ordinary skill in the art would also appreciate that such catalyst or binder material may be provided in the form of metal particles provided with diamond crystals or as a metal material that is swept through the layer from a tungsten carbide substrate on which the polycrystalline diamond layer is being formed, for example.

Other high pressure processes may include, for example, rapid omnidirectional compaction (ROC), such as that described in U.S. Pat. No. 6,106,957, which is herein incorporated by reference in its entirety. In the ROC process, a powder metal workpiece preform is disposed in a ceramic shell or envelope, heated to a desired elevated temperature and then placed in a pressure vessel and pressurized to compact the preform. The ceramic shell acts as a liquid die material and, when placed in a suitable pressure vessel and pressurized such as by the use of a hydraulic ram, the ceramic material is rapidly pressurized in a short time interval. The preform is thus rapidly isodynamically pressurized and consolidated.

In addition to the high pressure sintering which may allow for the 1) intercrystalline bonding and formation of polycrystalline diamond layer; 2) formation of a tungsten carbide substrate; and 3) provide for the sp²→sp³ conversion of carbon additives, in accordance with the embodiments of the present disclosure, various low pressure sintering techniques, such as hot isotatic processing (HIP) and vacuum sintering, may also be used prior to high pressure sintering. Such low pressure sintering may be used in combination with the high pressure sintering to form a tungsten carbide substrate and/or to convert a portion of sp³ carbon to sp² carbon. Depending one the pressure levels used in the sintering, a desired amount of sp²→sp³ conversion may occur.

HIP, as known in the art, is described in, for example, U.S. Pat. No. 5,290,507, which is herein incorporated by reference in its entirety. Isostatic pressing generally is used to produce powdered metal parts to near net sizes and shapes of varied complexity. Hot isostatic processing is performed in a gaseous (inert argon or helium) atmosphere contained within a pressure vessel. Typically, the gaseous atmosphere as well as the powder to be pressed are heated by a furnace within the vessel. Common pressure levels for HIP may extend upward to 45,000 psi with temperatures up to 3000° C. For tungsten carbide composites, typical processing conditions include temperatures ranging from 1200-1450° C. and pressures ranging from 800-1,500 psi. In the hot isostatic process, the powder to be hot compacted is placed in a hermetically sealed container, which deforms plastically at elevated temperatures. Prior to sealing, the container is evacuated, which may include a thermal out-gassing stage to eliminate residual gases in the powder mass that may result in undesirable porosity, high internal stresses, dissolved contaminants and/or oxide formation.

Vacuum sintering, as known in the art, is described in, for example, U.S. Pat. No. 4,407,775, which is herein incorporated by reference in its entirety. The power to be compacted is loaded in an open mold or container for consolidation. The powder is then consolidated by sintering in a vacuum. Suitable pressures for vacuum sintering are about 10⁻³ psi or less. Sintering temperatures must remain below the solidus temperature of the powder to avoid melting of the powder. One of ordinary skill in the art would recognize that in addition to these sintering techniques, other low pressure sintering processes, such as inert gas sintering and hot pressing, are within the scope of the present disclosure.

Moreover, in addition to the high pressure sintering and low pressure sintering, any of the precursor materials may also be subjected to low temperature pre-sintering, as known in the art, to remove organic binders, etc., and for ease of handling and assembly of the precursor materials to form a cutting element in accordance with the various embodiments of the present disclosure. Thus, the low temperature pre-sintering may be used prior to high pressure sintering or prior to low pressure sintering (when used in combination with high pressure sintering).

Exemplary Composite Cutting Structures

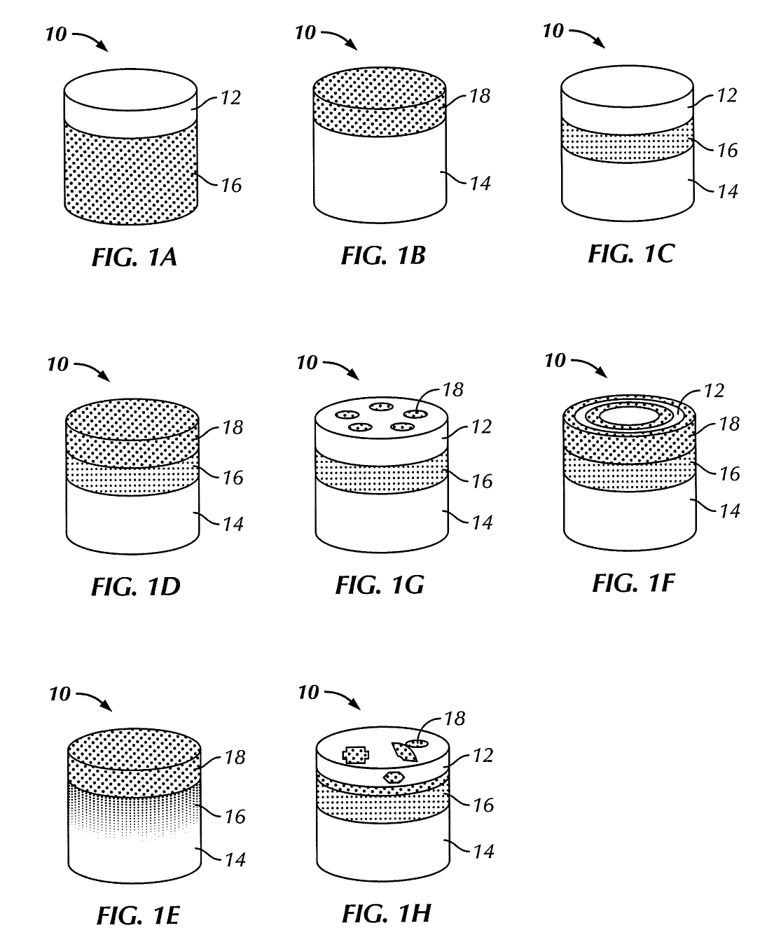

Referring to FIG. 1A, one embodiment of a cutting element designed for use in a drag bit is shown. As shown in FIG. 1A, cutter 10 includes a polycrystalline diamond cutting layer 12 disposed on a carbide substrate 16. Carbide substrate 16, however, is not a conventional carbide substrate, but instead has diamond grains distributed therein, formed from the sp²→sp³ conversion of the carbon additives during high pressure, high temperature sintering. Such sp²-containing carbon additives may be initially provided in the tungsten carbide/binder particle mixture, and remain distributed therethrough through low pressure sintering of the mixture in formation of the tungsten carbide substrate. One skilled in the art would appreciate that in such an embodiment, the polycrystalline diamond layer may be formed by placing diamond particles (and an optional binder) on a mixture of tungsten carbide particles (either layering the mixtures or using assemblies such as in green or pre-sintered state) or on a formed carbide substrate (still having sp²-containing carbon distributed therein), or a preformed polycrystalline diamond layer may be joined with the carbide substrate through high pressure sintering with a carbide substrate having sp²-containing carbon additives distributed therein (to convert sp² carbon to sp³ carbon (forming diamond)).

Such embodiment may be formed, for example, through at least a high pressure sintering; however, alternative embodiments may also use a low pressure sintering process. In embodiments using the optional low pressure sintering, the sp² carbon being converted to diamond may originate in the mixture as sp²-containing carbon, or may have been converted/graphitized (at least partially) to sp² carbon from sp³ carbon (from diamond, for example) during such preceding low pressure sintering. Further, one skilled in the art would appreciate that if an assembly of carbide and diamond (for forming the diamond table) is subjected to both a low pressure and high pressure sintering process, that the conditions of the low pressure may be controlled to avoid total graphitization of the diamond particles during that first low pressure sintering.

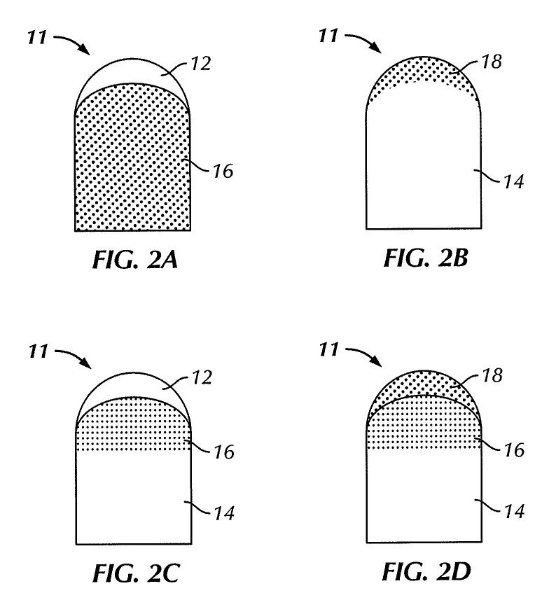

Similar to FIG. 1A, one embodiment of an insert for use in a roller cone bit is shown in FIG. 2A. Like cutter 10, insert 11 includes a tungsten carbide substrate 16 on which a diamond tip cutting layer 12 is formed. Further, while the geometry of insert 10 is shown as being a dome-top, one skilled in the art would appreciate that there is no limit on the geometries that may be used in accordance with various embodiments of the present disclosure. Additionally, one skilled in the art would appreciate that any of the cutting elements disclosed herein may also be provided with non-planar interfaces, as known in the art.

Turning now to FIGS. 1B and 2B, additional embodiments of cutter 10 and insert 11 are shown. As shown in FIGS. 1B and 2B, cutter 10 and insert 11 may include a conventional tungsten carbide substrate 14 on which a polycrystalline diamond layer 18 having been formed from inclusion of sp²-containing carbon additives distributed therethough may be disposed. Such sp²-containing carbon additives may be initially provided in the diamond particle and optional binder particle mixture, and may be converted to sp³ carbon (i.e., diamond) during high pressure sintering when intercrystalline bonding and formation of the polycrystalline diamond layer occurs. One skilled in the art would appreciate that in such an embodiment, the polycrystalline diamond layer may be formed by placing diamond particles, sp²-containing carbon additives (and an optional binder) on an unsintered mixture of tungsten carbide particles, on a pre-formed (sintered, green, or partially sintered) carbide substrate, or may be formed separate from the tungsten carbide substrate and subsequently joined through sintering with a carbide substrate. A low pressure sintering may optionally be used when forming the carbide substrate, similar to as described above.

Further, while FIGS. 1A-B and 2A-B show embodiments having converted sp²-containing carbon additives distributed through an entire diamond or carbide layer (i.e., uniform distribution), the present disclosure is not so limited. Rather, as shown in FIGS. 1C and 2C, converted sp²-containing carbon additives (i.e., diamond grains) may be distributed through only a portion of a carbide substrate (i.e., non-uniform distribution), thus forming a carbide region 16 having diamond grains distributed therethrough as well as a conventional carbide region 14.

It is also within the scope of the present disclosure that sp²-containing carbon additives may be incorporated into both the diamond layer as well as the carbide substrate (or at least in a portion of each layer). Thus, for example, as shown in FIGS. 1D and 2D, converted sp²-containing carbon additives (diamond grains) are distributed through only a portion of a carbide substrate (i.e., non-uniform distribution), thus forming a carbide region 16 having diamond grains distributed therethrough as well as a conventional carbide region 14. Adjacent the carbide region 16 having diamond grains distributed therethrough is a polycrystalline diamond layer 18 having been formed from inclusion of sp²-containing carbon additives distributed therethough.

Additionally, one skilled in the art would appreciate similar embodiments involving non-uniform distribution of diamond (formed from sp²-containing carbon additives) through a polycrystalline diamond layer are also within the scope of the present disclosure. Such embodiments may be formed similar to the embodiments described above, with sp²-containing carbon additives (or sp²-convertible carbon additives) being present in both the tungsten carbide mixture and diamond mixture. While FIGS. 1D and 2D show two discrete carbide regions 14 and 16, one skilled in the art would also appreciate that non-uniform distribution of converted sp²-containing carbon additives may also include a gradient of the converted additives distributed through a carbide substrate and/or diamond layer. For example, as shown in FIG. 1E, diamond grains (converted from sp²-containing carbon additives) are distributed in a gradient through a portion of a carbide substrate (i.e., non-uniform distribution), thus forming a carbide region 16 having diamond grains distributed unevenly therethrough as well as a conventional carbide region 14. Adjacent the carbide region 16 having diamond grains distributed therethrough is a polycrystalline diamond layer 18 having been formed from inclusion of sp²-containing carbon additives distributed therethough. The diamonds distributed through carbide region 16 are greatest adjacent the diamond layer 18, and decrease gradually with increasing distance from diamond layer 18, to a point where no diamond are distributed therethrough at carbide region 14.

Moreover, while FIG. 1E shows a gradual or continuous variation in free converted sp²-containing carbon additives/diamond resulting from additive distribution, the present invention is not so limited. Thus, for example, such converted additives may also be distributed through a portion of a cutting element in a non-continuous manner, as shown in FIGS. 1F-1H, such non-continuous variation of converted additive distribution may take any geometric or irregular shape, varying through each direction of three dimensional space.

Carbide substrates may be formed by mixing carbide particles with a metal catalyst (and sp² or sp²-convertible carbon additives if distribution of diamond grains through a carbide substrate is desired). The amount of carbide may range from about 70 to 96 percent by weight while the binder may range from about 4 to 30 percent by weight. The amount of sp² or sp²-convertible carbon additives may range from 0 to 30 percent by weight of the carbide precursor materials mixture. Among the types of tungsten carbide particles that may be used to form carbide substrates of the present disclosure include cast tungsten carbide, macro-crystalline tungsten carbide, carburized tungsten carbide, and cemented tungsten carbide. Further, the particles sizes of the carbide particles that may be used to form the carbide substrates may range from 0.5 to 20 microns.

As discussed above, one type of tungsten carbide is macrocrystalline carbide. This material is essentially stoichiometric WC in the form of single crystals. Most of the macrocrystalline tungsten carbide is in the form of single crystals, but some bicrystals of WC may form in larger particles. The manufacture of macrocrystalline tungsten carbide is disclosed, for example, in U.S. Pat. Nos. 3,379,503 and 4,834,963, which are herein incorporated by reference.

U.S. Pat. No. 6,287,360, which is assigned to the assignee of the present invention and is herein incorporated by reference, discusses the manufacture of carburized tungsten carbide. Carburized tungsten carbide, as known in the art, is a product of the solid-state diffusion of carbon into tungsten metal at high temperatures in a protective atmosphere. Carburized tungsten carbide grains are typically multi-crystalline, i.e., they are composed of WC agglomerates. Typical carburized tungsten carbide contains a minimum of 99.8% by weight of carbon infiltrated WC, with a total carbon content in the range of about 6.08% to about 6.18% by weight. Tungsten carbide grains designated as WC MAS 2000 and 3000-5000, commercially available from H. C. Stark, are carburized tungsten carbides suitable for use in the formation of the matrix bit body disclosed herein. The MAS 2000 and 3000-5000 carbides have an average size of 20 and 30-50 micrometers, respectively, and are coarse grain conglomerates formed as a result of the extreme high temperatures used during the carburization process.

Another form of tungsten carbide is cemented tungsten carbide (also known as sintered tungsten carbide), which is a material formed by mixing particles of tungsten carbide, typically monotungsten carbide, and cobalt particles, and sintering the mixture. Methods of manufacturing cemented tungsten carbide are disclosed, for example, in U.S. Pat. Nos. 5,541,006 and 6,908,688, which are herein incorporated by reference. Sintered tungsten carbide is commercially available in two basic forms: crushed and spherical (or pelletized). Crushed sintered tungsten carbide is produced by crushing sintered components into finer particles, resulting in more irregular and angular shapes, whereas pelletized sintered tungsten carbide is generally rounded or spherical in shape.

Briefly, in a typical process for making cemented tungsten carbide, a tungsten carbide powder having a predetermined size (or within a selected size range) is mixed with a suitable quantity of cobalt, nickel, or other suitable binder. The mixture is typically prepared for sintering by either of two techniques: it may be pressed into solid bodies often referred to as green compacts, or alternatively, the mixture may be formed into granules or pellets such as by pressing through a screen, or tumbling and then screened to obtain more or less uniform pellet size. Such green compacts or pellets are then heated in a controlled atmosphere furnace to a temperature near the melting point of cobalt (or the like) to cause the tungsten carbide particles to be bonded together by the metallic phase. Sintering globules of tungsten carbide specifically yields spherical sintered tungsten carbide. Crushed cemented tungsten carbide may further be formed from the compact bodies or by crushing sintered pellets or by forming irregular shaped solid bodies.

The particle size and quality of the sintered tungsten carbide can be tailored by varying the initial particle size of tungsten carbide and cobalt, controlling the pellet size, adjusting the sintering time and temperature, and/or repeated crushing larger cemented carbides into smaller pieces until a desired size is obtained. In one embodiment, tungsten carbide particles (unsintered) having an average particle size of between about 0.2 to about 20 microns are sintered with cobalt to form either spherical or crushed cemented tungsten carbide. In a preferred embodiment, the cemented tungsten carbide is formed from tungsten carbide particles having an average particle size of about 0.8 to about 7 microns. In some embodiments, the amount of cobalt present in the cemented tungsten carbide is such that the cemented carbide is comprised of from about 6 to 16 weight percent cobalt.

Cast tungsten carbide is another form of tungsten carbide and has approximately the eutectic composition between bitungsten carbide, W₂C, and monotungsten carbide, WC. Cast carbide is typically made by resistance heating tungsten in contact with carbon, and is available in two forms: crushed cast tungsten carbide and spherical cast tungsten carbide. Processes for producing spherical cast carbide particles are described in U.S. Pat. Nos. 4,723,996 and 5,089,182, which are herein incorporated by reference. Briefly, tungsten may be heated in a graphite crucible having a hole through which a resultant eutectic mixture of W₂C and WC may drip. This liquid may be quenched in a bath of oil and may be subsequently comminuted or crushed to a desired particle size to form what is referred to as crushed cast tungsten carbide. Alternatively, a mixture of tungsten and carbon is heated above its melting point into a constantly flowing stream which is poured onto a rotating cooling surface, typically a water-cooled casting cone, pipe, or concave turntable. The molten stream is rapidly cooled on the rotating surface and forms spherical particles of eutectic tungsten carbide, which are referred to as spherical cast tungsten carbide.

The standard eutectic mixture of WC and W₂C is typically about 4.5 weight percent carbon. Cast tungsten carbide commercially used as a matrix powder typically has a hypoeutectic carbon content of about 4 weight percent. In one embodiment of the present invention, the cast tungsten carbide used in the mixture of tungsten carbides is comprised of from about 3.7 to about 4.2 weight percent carbon.

The various tungsten carbides disclosed herein may be selected so as to provide a bit that is tailored for a particular drilling application. For example, the type, shape, and/or size of carbide particles used in the formation of cutting element may affect the material properties of the formed cutting element, including, for example, fracture toughness, transverse rupture strength, and erosion resistance.

The composite of the present disclosure may also include a binder or catalyst for compaction. Catalyst materials that may be used to form the relative ductile phase of the various composites of the present disclosure may include various group IVa, Va, and VIa ductile metals and metal alloys including, but not limited to Fe, Ni, Co, Cu, Ti, Al, Ta, Mo, Nb, W, V, and alloys thereof, including alloys with materials selected from C, B, Cr, and Mn. In a particular embodiment, the composite may include from about 4 to about 40 weight percent metallic binder. Such binders may also be used to form polycrystalline diamond layers, as described below.

A polycrystalline diamond body may be formed similar to the formation of a conventional PCD layer. To form the polycrystalline diamond object, an unsintered mass of diamond crystalline particles is placed within a metal enclosure of the reaction cell of a HPHT apparatus. A metal catalyst, such as cobalt or other metals mentioned above, may be included with the unsintered mass of crystalline particles to promote intercrystalline diamond-to-diamond bonding. The catalyst material may be provided in the form of powder and mixed with the diamond grains, or may be infiltrated into the diamond grains from an adjacent carbide substrate during HPHT sintering

Diamond grains useful for forming a polycrystalline diamond body may include any type of diamond particle, including natural or synthetic diamond powders having a wide range of grain sizes. For example, such diamond powders may have an average grain size in the range from submicrometer in size to 100 micrometers, and from 1 to 80 micrometers in other embodiments. Further, one skilled in the art would appreciate that the diamond powder may include grains having a mono- or multi-modal distribution.

Further, when incorporating sp² or sp²-convertible carbon additives into precursor materials (either carbide or diamond mixtures), such additives may be added in an amount ranging from about 0.1 to 30 weight percent, and from about 2 to 10 weight percent in another embodiment.

Following one or more high and low pressure processes, the cutting structures may be subjected to a typical finishing process, as known in the art, prior to incorporation of the piece into the desired application. Composites of this invention can be used in a number of different applications, such as tools for mining and construction applications, where mechanical properties of high fracture toughness, wear resistance, and hardness are highly desired. Composites of this invention can be used to form wear and cutting components in such downhole cutting tools as roller cone bits, percussion or hammer bits, and drag bits, and a number of different cutting and machine tools.

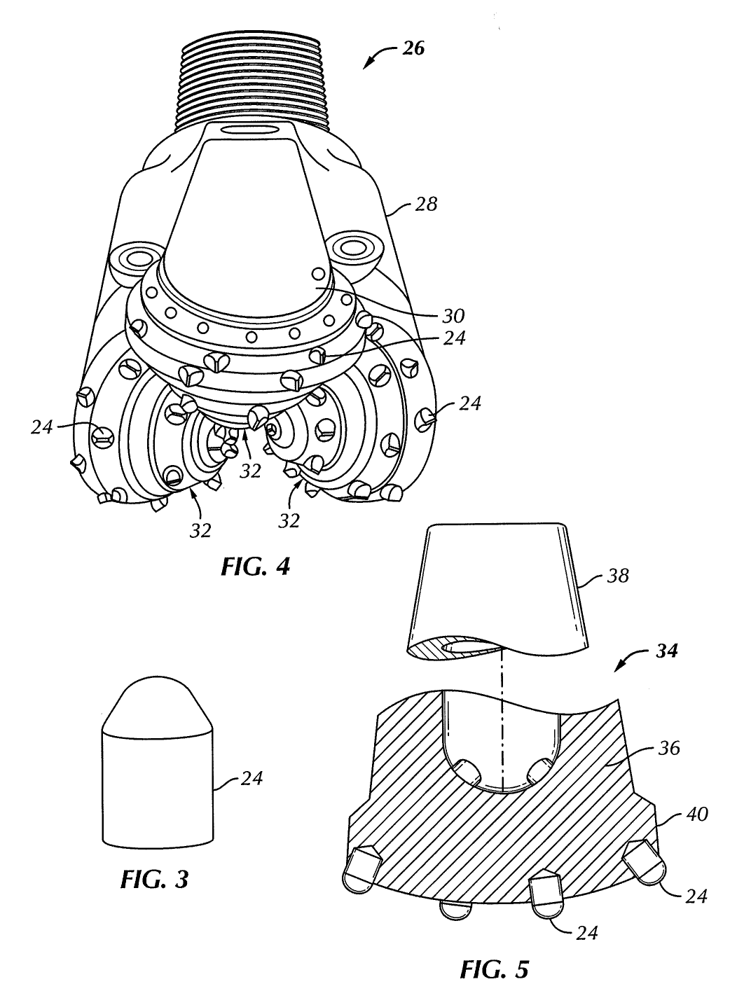

FIG. 3, for example, illustrates a mining or drill bit insert 24 used in accordance with one embodiment of the present disclosure. Referring to FIG. 4, such an insert 24 can be used with a roller cone drill bit 26 comprising a body 28 having three legs 30, and a cutter cone 32 mounted on a lower end of each leg. Each roller cone bit insert 24 can be fabricated according to one of the methods described above. The inserts 24 are provided in the surfaces of the cutter cone 32 for bearing on a rock formation being drilled.

Referring to FIG. 5, inserts 24 formed from composites of the present disclosure may also be used with a percussion or hammer bit 34, comprising a hollow steel body 36 having a threaded pin 38 on an end of the body for assembling the bit onto a drill string (not shown) for drilling oil wells and the like. A plurality of the inserts 24 are provided in the surface of a head 40 of the body 36 for bearing on the subterranean formation being drilled.

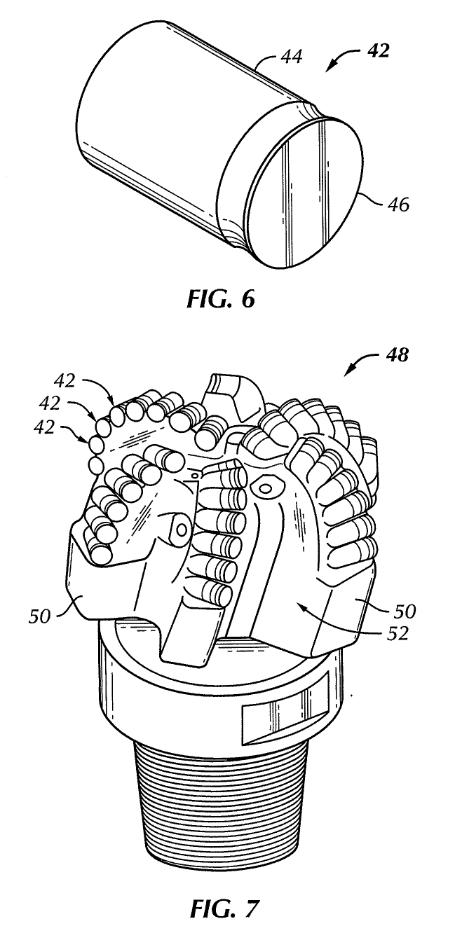

Referring to FIG. 6, composites of the present disclosure may also be used to form shear cutters 42 that are used, for example, with a drag bit for drilling subterranean formations. More specifically, composites may be used to form a sintered surface layer 46 on a cutter or substrate 44. Referring to FIG. 7, a drag bit 48 comprises a plurality of such shear cutters 42 that are each attached to blades 50 that extend from a head 52 of the drag bit for cutting against the subterranean formation being drilled. In a particular embodiment, cutters 42 includes a carbide substrate (not shown) formed via a conventional sintering process and HTHP process, as disclosed herein, and a diamond cutting face (not shown) attached thereto following the multiple processes. One of ordinary skill in the art would recognize that in various embodiments other types of cutting elements (such as inserts 24 shown in FIG. 3) formed from composites of the present disclosure may also be used in drag bit 48.

Advantageously, embodiments of the present disclosure may include one or more of the following. Conventional cutting elements have a large amount of residual stresses present at the interface between a carbide substrate and polycrystalline diamond cutting layer, which leads to cracking and delamination. By incorporating sp² or sp²-convertible carbons additives (and thus formed diamond grains) into the cutting element, a reduction of the residual stress may be achieved, leading to decreased incidents of cracking and delamination. For example, embodiments of the present disclosure may provide for diamond-diamond bonds across the interface or may reduce the material mismatch due to the differences between thermal expansion coefficients.

Further, residual stresses are typically higher as the diameter of the cutting element decreases or as the thickness of the diamond layer increases. By reducing the residual stresses by altering the material composite, a thicker diamond layer and/or smaller diameter cutting elements may be achieved. For embodiments where sp² or sp²-convertible carbons additives (diamond) is provided in the carbide substrate, the formation of diamond within the substrate improves the thermal conductivity of the substrate, allowing for better/faster cooling of the diamond layer during use. Moreover, when incorporating sp² carbon additives into the precursor materials for forming polycrystalline diamond, better bonding between the diamond particles may be achieved.

Additionally, in inserts for roller cone bits having a dome or other geometry top on which a thin diamond layer may be disposed, by providing the underlying tungsten carbide substrate with diamond grains distributed at least through an upper portion thereof (at least in the interface region), as the insert wears, and wears through the diamond cutting tip, diamond present in the carbide may allow the insert to have greater durability and avoid a sharp drop in wear performance upon wearing through the diamond cutting tip.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A method for forming a cutting element, comprising:
sintering a mixture comprising carbide particles, a sp²-containing or sp²-convertible carbon additive, and a metallic binder at a first processing condition having a pressure of greater than about 100,000 psi to form a sintered object.

2. The method of claim 1, further comprising
sintering the mixture, prior to the first processing condition, at a second processing condition having a pressure of less than about 45,000 psi.

3. The method of claim 2, wherein the sp²-convertible carbon additive comprises diamond particles.

4. The method of claim 1, further comprising:
forming a polycrystalline diamond layer on the sintered object during the first sintering processing condition.

5. The method of claim 4, further comprising:
sintering the mixture, prior to the first processing condition, at a second processing condition having a pressure of less than about 45,000 psi to form the sintered object; and
adding diamond particles to the sintered object prior to the sintering at the first processing condition.

6. The method of claim 5, wherein the sp²-containing or sp²-convertible carbon additive comprises at least one of graphite, diamond particles, amorphous carbon, and combinations thereof.

7. The method of claim 3, wherein the diamond particles have a sp²-containing carbon additive added therewith.

8. The method of claim 4, assembling into two adjacent regions the mixture and diamond particles prior to the sintering at the first processing condition.

9. The method of claim 8, wherein the sp²-containing or sp²-convertible carbon additive comprises a sp²-containing carbon additive.

10. The method of claim 9, wherein the sp²-containing or sp²-convertible carbon additive further comprises diamond particles.

11. The method of claim 8, wherein the diamond particles have a sp²-containing carbon additive added therewith.

12. The method of claim 8, further comprising:
sintering the assembly, prior to the first processing condition, at a second processing condition having a pressure of less than about 45,000 psi.

13. The method of claim 12, wherein the wherein the sp²-containing or sp²-convertible carbon additive comprises at least one of graphite, diamond particles, amorphous carbon, and combinations thereof.

14. The method of claim 12, wherein the diamond particles have a sp²-containing carbon additive added therewith.

15. The method of claim 1, further comprising:
attaching a preformed polycrystalline diamond layer to the sintered object during the sintering at the first processing condition.

16. The method of claim 1, wherein the sp²-containing or sp²-convertible carbon additive is non-uniformly distributed through the mixture.

17. The method of claim 16, wherein the non-uniform distribution is a gradual variation.

18. The method of claim 16, wherein the non-uniform distribution is a discontinuous variation.

19. The method of claim 1, wherein the sp²-containing or sp²-convertible carbon additive is uniformly distributed through the mixture.

20. A method for forming a cutting element, comprising:
sintering a mixture comprising diamond particles and a sp²-containing carbon additive at a first processing condition having a pressure of greater than about 100,000 psi to form a polycrystalline diamond layer.

21. The method of claim 20, further comprising:
joining the polycrystalline diamond layer to a carbide substrate.

22. The method of claim 21, wherein the joining occurs during the sintering at the first processing condition, and wherein the mixture of diamond particles and the sp²-containing carbon additive are provided on a preformed carbide substrate.

23. The method of claim 22, wherein the preformed carbide substrate is one of green, partially sintered, and pre-sintered.

24. The method of claim 21, wherein the joining occurs during the sintering at the first processing condition, and wherein the mixture of diamond particles and sp²-containing carbon additive are provided on a mixture comprising tungsten carbide particles and a metallic binder to form an assembly, and wherein the method further comprises:
sintering the assembly, prior to the first processing condition, at a second processing condition having a pressure of less than about 45,000 psi to form a carbide substrate.

25. The method of claim 21, wherein the joining occurs during the sintering at the first processing condition, and wherein the method further comprises
sintering a mixture of carbide particles and a metallic binder at a second processing condition having a pressure of less than about 45,000 psi to form a carbide substrate; and
placing the mixture of diamond particles and sp²-containing carbon additive on the carbide substrate prior to the sintering at the first processing condition.

26. The method of claim 20, wherein the sp²-containing carbon additive is non-uniformly distributed through the mixture.

27. The method of claim 26, wherein the non-uniform distribution is a gradual variation.

28. The method of claim 26, wherein the non-uniform distribution is a discontinuous variation.

29. The method of claim 20, wherein the sp²-containing carbon additive is uniformly distributed through the mixture.

30. A cutting element, comprising:
a tungsten carbide substrate; and
a polycrystalline diamond layer;
wherein single diamond grains are non-uniformly distributed through the cutting element.

31. The cutting element of claim 30, wherein the single diamond grains are distributed through the entire tungsten carbide substrate.

32. The cutting element of claim 30, wherein the single diamond grains are non-uniformly distributed through the tungsten carbide substrate.

33. The cutting element of claim 30, wherein the single diamond grains are distributed across an interface between the tungsten carbide substrate and the polycrystalline diamond layer.

34. The cutting element of claim 30, wherein the polycrystalline diamond layer was formed from a mixture comprising diamond grains and a sp²-containing or sp²-convertible carbon additive.

35. A cutting element, comprising:
a tungsten carbide substrate; and
a polycrystalline diamond layer formed from a mixture of diamond grains and a sp²-containing carbon additive;
wherein the sp²-containing carbon additive was non-uniformly distributed through the cutting element.
